(19) United States
(12) Patent Application Publication
(10) Pub. No.: US 2026/0136222 A1
(43) Pub. Date: May 14, 2026

(54) CHANNEL STATE INFORMATION MEASUREMENT CONFIGURATION FOR A CANDIDATE CELL IN LAYER 1 AND LAYER 2 MOBILITY

(71) Applicant: QUALCOMM Incorporated, San Diego, CA (US)

(72) Inventors: Fang YUAN, Beijing (CN); Yan ZHOU, San Diego, CA (US)

(21) Appl. No.: 19/118,231

(22) PCT Filed: Nov. 23, 2022
(86) PCT No.: PCT/CN2022/133659

§ 371 Date: Apr. 3, 2025

(51) Int. Cl. H04W 24/10

(52) U.S. Cl. CPC H04W 24/10

(57) ABSTRACT

Various aspects of the present disclosure generally relate to wireless communication. In some aspects, a user equipment (UE) may receive, from a network node, a channel state information (CSI) measurement configuration configuring one or more Layer 1 (L1) measurements for a candidate cell. The UE may obtain the one or more L1 measurements for the candidate cell based at least in part on the CSI measurement configuration. The UE may transmit, to the network node, an L measurement report that indicates the one or more L1 measurements for the candidate cell. Numerous other aspects are described.

### FIELD OF THE DISCLOSURE

Aspects of the present disclosure generally relate to wireless communication and to techniques and apparatuses associated with a channel state information (CSI) measurement configuration for a candidate cell in Layer 1 and Layer 2 mobility.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a network node, a channel state information (CSI) measurement configuration configuring one or more Layer 1 (L1) measurements for a candidate cell. The method may include obtaining the one or more L1 measurements for the candidate cell based at least in part on the CSI measurement configuration. The method may include transmitting, to the network node, an L1 measurement report that indicates the one or more L1 measurements for the candidate cell.

Some aspects described herein relate to a method of wireless communication performed by a network node. The method may include transmitting, to a UE, a CSI measurement configuration configuring one or more L1 measurements for a candidate cell. The method may include receiving, from the UE, an L1 measurement report that indicates the one or more L1 measurements for the candidate cell.

Some aspects described herein relate to a UE for wireless communication. The UE may include a memory and one or more processors coupled to the memory. The one or more processors may be configured to receive, from a network node, a CSI measurement configuration configuring one or more L1 measurements for a candidate cell. The one or more processors may be configured to obtain the one or more L1 measurements for the candidate cell based at least in part on the CSI measurement configuration. The one or more processors may be configured to transmit, to the network node, an L1 measurement report that indicates the one or more L1 measurements for the candidate cell.

Some aspects described herein relate to a network node for wireless communication. The network node may include a memory and one or more processors coupled to the memory. The one or more processors may be configured to transmit, to a UE, a CSI measurement configuration configuring one or more L1 measurements for a candidate cell. The one or more processors may be configured to receive, from the UE, an L1 measurement report that indicates the one or more L1 measurements for the candidate cell.

Some aspects described herein relate to a non-transitory computer-readable medium that stores a set of instructions for wireless communication by a UE. The set of instructions, when executed by one or more processors of the UE, may cause the UE to receive, from a network node, a CSI measurement configuration configuring one or more L1 measurements for a candidate cell. The set of instructions, when executed by one or more processors of the UE, may cause the UE to obtain the one or more L1 measurements for the candidate cell based at least in part on the CSI measurement configuration. The set of instructions, when executed by one or more processors of the UE, may cause the UE to transmit, to the network node, an L1 measurement report that indicates the one or more L1 measurements for the candidate cell.

Some aspects described herein relate to a non-transitory computer-readable medium that stores a set of instructions for wireless communication by a network node. The set of instructions, when executed by one or more processors of the network node, may cause the network node to transmit, to a UE, a CSI measurement configuration configuring one or more L1 measurements for a candidate cell. The set of instructions, when executed by one or more processors of the network node, may cause the network node to receive, from the UE, an L1 measurement report that indicates the one or more L1 measurements for the candidate cell.

Some aspects described herein relate to an apparatus for wireless communication. The apparatus may include means for receiving, from a network node, a CSI measurement configuration configuring one or more L1 measurements for a candidate cell. The apparatus may include means for obtaining the one or more L1 measurements for the candidate cell based at least in part on the CSI measurement configuration. The apparatus may include means for transmitting, to the network node, an L1 measurement report that indicates the one or more L1 measurements for the candidate cell.

Some aspects described herein relate to an apparatus for wireless communication. The apparatus may include means for transmitting, to a UE, a CSI measurement configuration configuring one or more L1 measurements for a candidate cell. The apparatus may include means for receiving, from the UE, an L1 measurement report that indicates the one or more L1 measurements for the candidate cell.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a make-before-break handover procedure, in accordance with the present disclosure.

FIGS. 5A-5B are diagrams illustrating examples of Layer 1 (L1) and/or Layer 2 (L2) inter-cell mobility, in accordance with the present disclosure.

FIG. 6 is a diagram illustrating examples of a cell update in L1/L2 inter-cell mobility scenarios, in accordance with the present disclosure.

FIGS. 7A-7C are diagrams illustrating examples associated with a channel state information (CSI) measurement configuration for a candidate cell in L1/L2 mobility, in accordance with the present disclosure.

FIGS. 8-9 are diagrams illustrating example processes associated with a CSI measurement configuration for a candidate cell in L1/L2 mobility, in accordance with the present disclosure.

FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

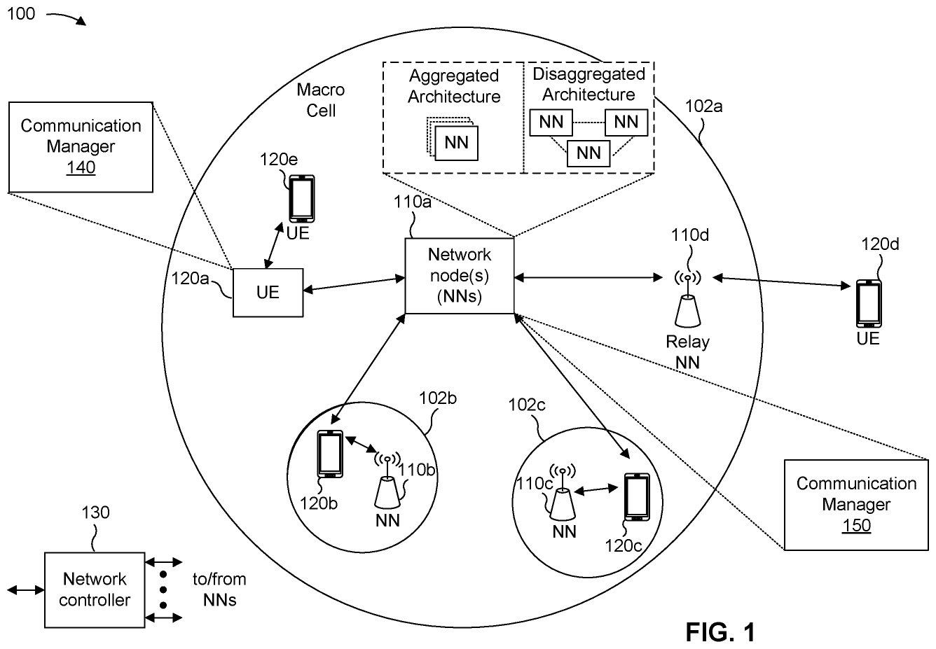

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR 1 is greater than 6 GHz, FR 1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node 110, a channel state information (CSI) measurement configuration configuring one or more Layer 1 (L1) measurements for a candidate cell; obtain the one or more L1 measurements for the candidate cell based at least in part on the CSI measurement configuration; and transmit, to the network node 110, an L1 measurement report that indicates the one or more L1 measurements for the candidate cell. Additionally, or alternatively, the communication manager 140 may perform one or more other operations described herein.

In some aspects, the network node 110 may include a communication manager 150. As described in more detail elsewhere herein, the communication manager 150 may transmit, to a UE 120, a CSI measurement configuration configuring one or more L1 measurements for a candidate cell; and receive, from the UE 120, an L1 measurement report that indicates the one or more L1 measurements for the candidate cell. Additionally, or alternatively, the communication manager 150 may perform one or more other operations described herein.

As indicated above, FIG. 1 is provided as an example. Other examples may differ from what is described with regard to FIG. 1.

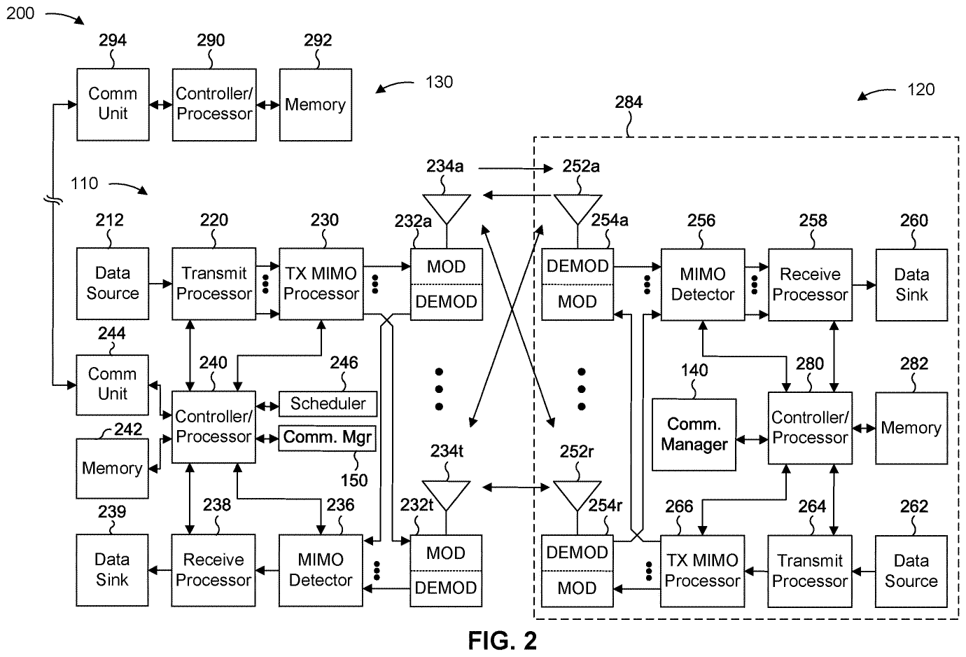

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252 a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

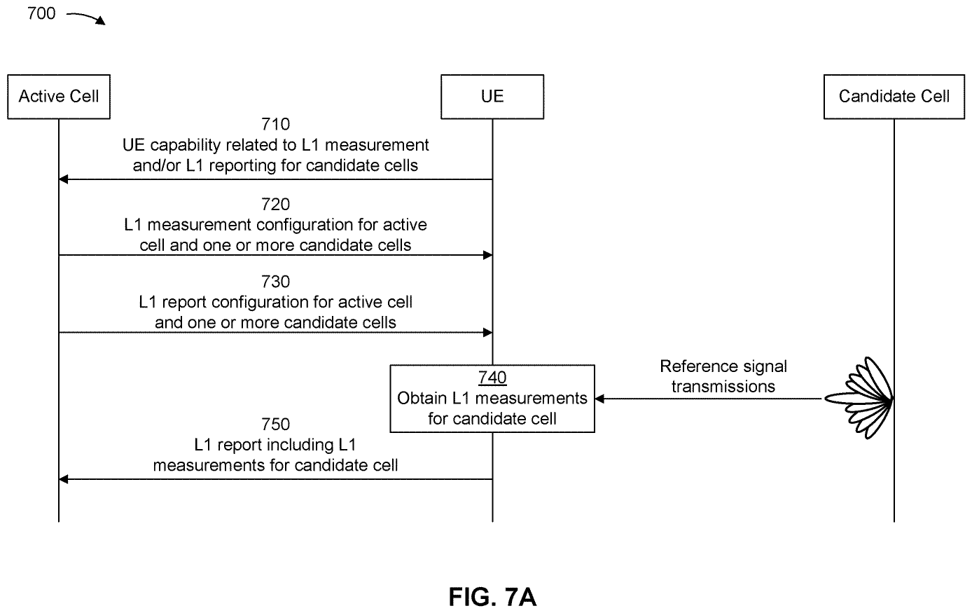

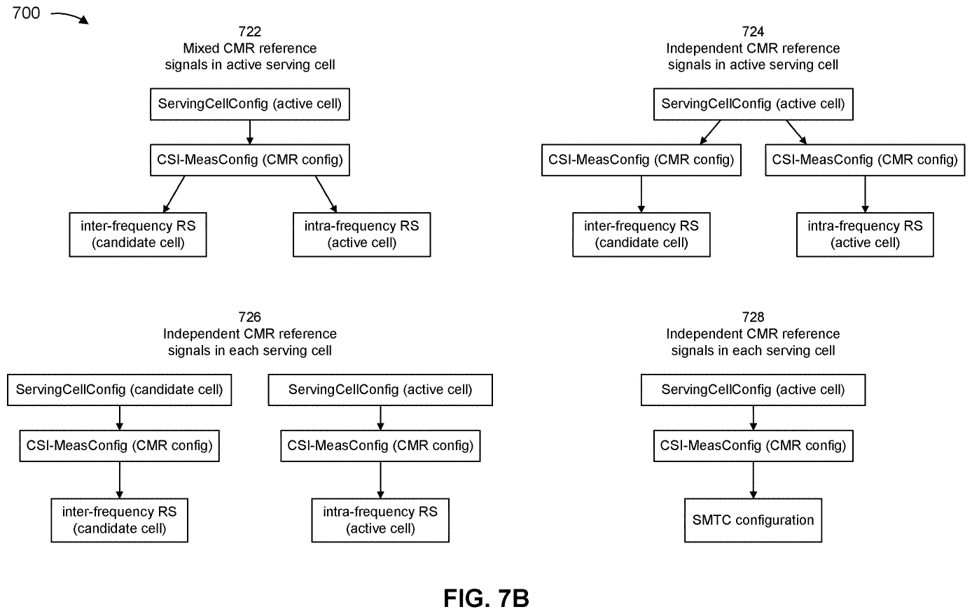

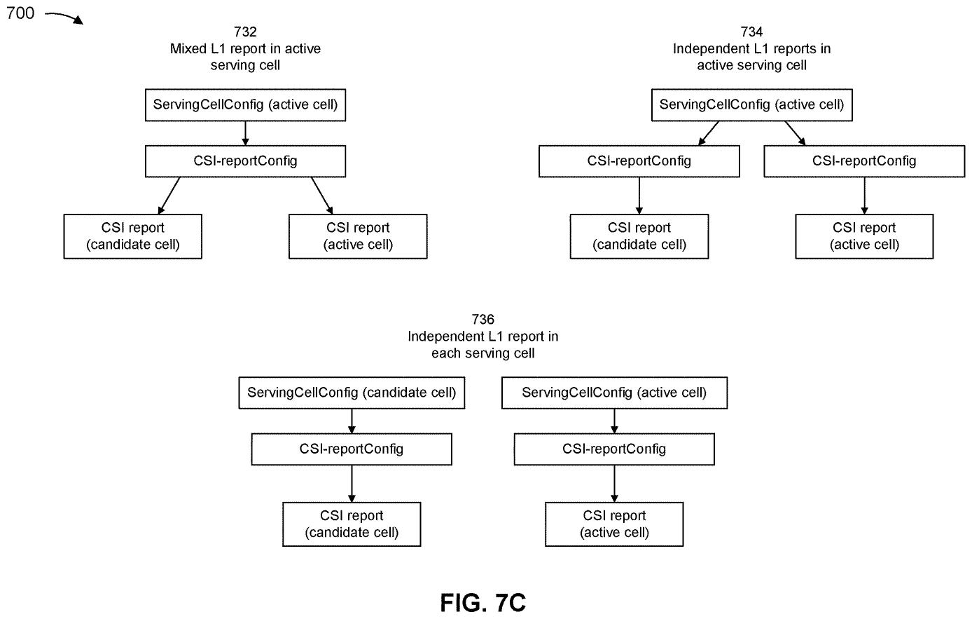

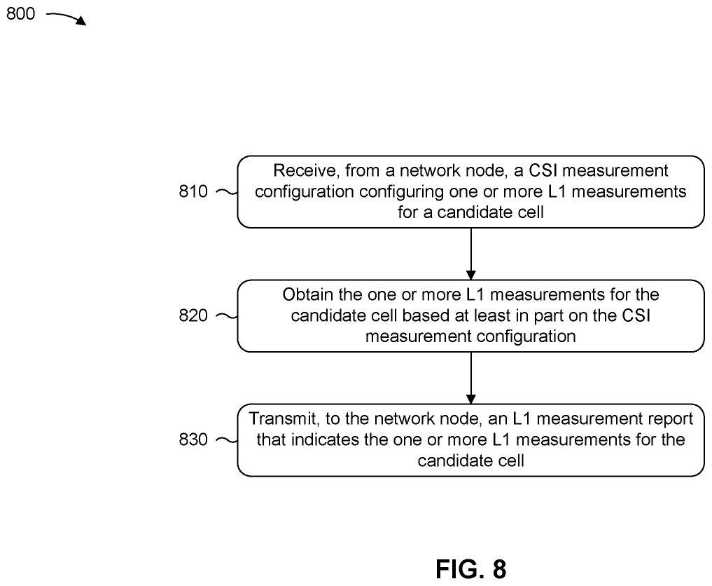

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-7C and/or FIGS. 8-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-7C and/or FIGS. 8-11).

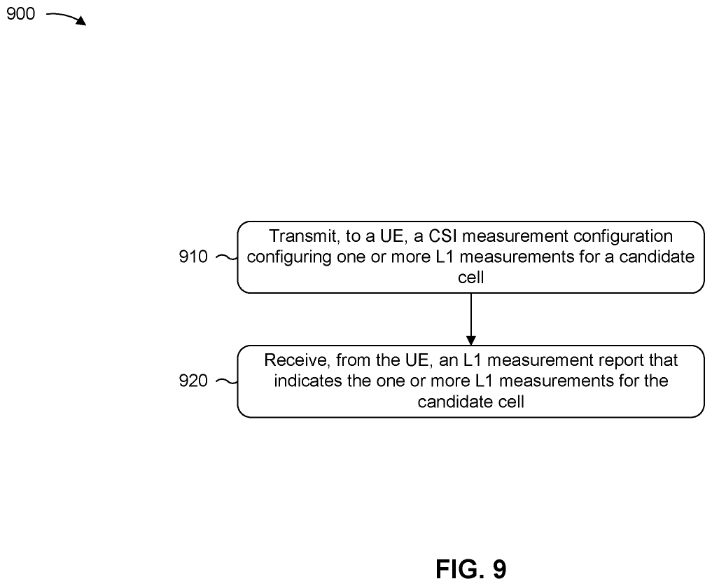

The controller/processor 240 of the network node 110, the controller/processor 280 of the UE 120, and/or any other component(s) of FIG. 2 may perform one or more techniques associated with a CSI measurement configuration for a candidate cell in L1 and Layer 2 (L2) mobility, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving, from a network node 110, a CSI measurement configuration configuring one or more L1 measurements for a candidate cell; means for obtaining the one or more L1 measurements for the candidate cell based at least in part on the CSI measurement configuration; and/or means for transmitting, to the network node 110, an L1 measurement report that indicates the one or more L1 measurements for the candidate cell. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE 120, a CSI measurement configuration configuring one or more L1 measurements for a candidate cell; and/or means for receiving, from the UE 120, an L1 measurement report that indicates the one or more L1 measurements for the candidate cell. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

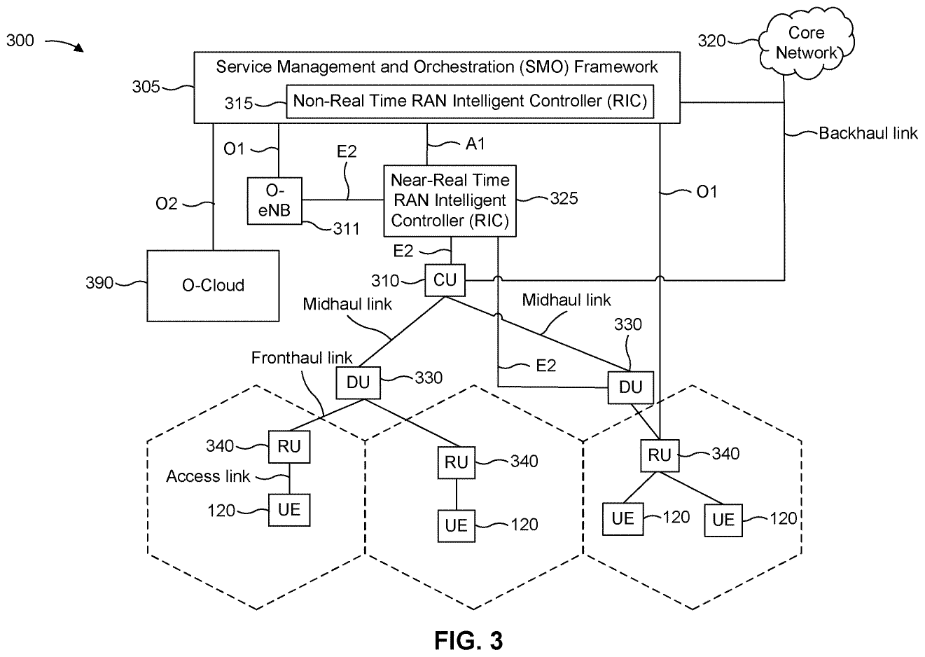

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

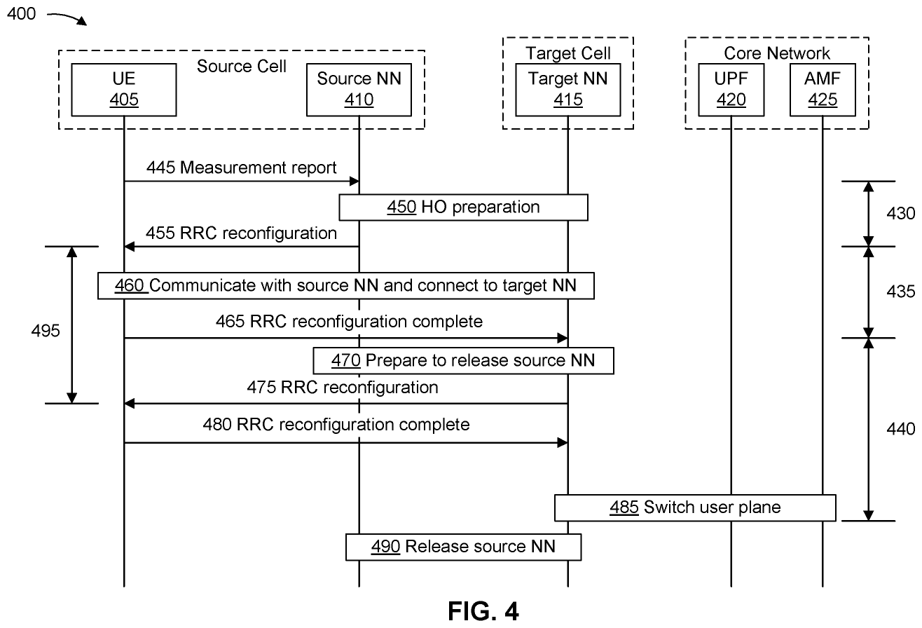

FIG. 4 is a diagram illustrating an example of a make-before-break (MBB) handover procedure, in accordance with the present disclosure.

As shown in FIG. 4, the MBB handover procedure may involve a UE 405, a source network node 410, a target network node 415, a user plane function (UPF) device 420, and an access and mobility management function (AMF) device 425. In some examples, actions described as being performed by a network node may be performed by multiple network nodes. For example, configuration actions and/or core network communication actions may be performed by a first network node (e.g., a CU or a DU), and radio communication actions may be performed by a second network node (e.g., a DU or an RU). The UE 405 may correspond to the UE 120 described elsewhere herein. The source network node 410 and/or the target network node 415 may correspond to the network node 110 described elsewhere herein. The UPF device 420 and/or the AMF device 425 may correspond to the network controller 130 described elsewhere herein. The UE 405 and the source network node 410 may be connected (e.g., may have an RRC connection) via a serving cell or a source cell, and the UE 405 may undergo a handover to the target network node 415 via a target cell. The UPF device 420 and/or the AMF device 425 may be located within a core network. The source network node 410 and the target network node 415 may be in communication with the core network for mobility support and user plane functions.

As shown in FIG. 4, the MBB handover procedure may include a handover preparation phase 430, a handover execution phase 435, and a handover completion phase 440. During the handover preparation phase 430, the UE 405 may report measurements that cause the source network node 410 and/or the target network node 415 to prepare for handover and trigger execution of the handover. During the handover execution phase 435, the UE 405 may execute the handover by performing a random access procedure with the target network node 415 and establishing an RRC connection with the target network node 415. During the handover completion phase 440, the source network node 410 may forward stored communications associated with the UE 405 to the target network node 415, and the UE 405 may be released from a connection with the source network node 410.

As shown by reference number 445, during the handover preparation phase 430, the UE 405 may perform one or more measurements, and may transmit a measurement report to the source network node 410 based at least in part on the one or more measurements (e.g., serving cell measurements and/or neighbor cell measurements). The measurement report may indicate, for example, an RSRP parameter, an RSRQ parameter, an RSSI parameter, and/or a signal-to-interference-plus-noise-ratio (SINR) parameter (e.g., for the serving cell and/or one or more neighbor cells). The source network node 410 may use the measurement report to determine whether to trigger a handover to the target network node 415. For example, if one or more measurements satisfy a condition, the source network node 410 may trigger a handover of the UE 405 to the target network node 415.

As shown by reference number 450, during the handover preparation phase 430, the source network node 410 and the target network node 415 may communicate with one another to prepare for a handover of the UE 405. As part of the handover preparation, the source network node 410 may transmit a handover request to the target network node 415 to instruct the target network node 415 to prepare for the handover. The source network node 410 may communicate RRC context information associated with the UE 405 and/or configuration information associated with the UE 405 to the target network node 415. The target network node 415 may prepare for the handover by reserving resources for the UE 405. After reserving the resources, the target network node 415 may transmit an acknowledgement (ACK) to the source network node 410 in response to the handover request.

As shown by reference number 455, during the handover preparation phase 430, the source network node 410 may transmit an RRC reconfiguration message to the UE 405. The RRC reconfiguration message may include a handover command instructing the UE 405 to execute a handover procedure from the source network node 410 to the target network node 415. The handover command may include information associated with the target network node 415, such as a random access channel (RACH) preamble assignment for accessing the target network node 415. Reception of the RRC reconfiguration message, including the handover command, by the UE 405 may trigger the start of the handover execution phase 435.

As shown by reference number 460, during the handover execution phase 435, the UE 405 may execute the handover by performing a random access procedure with the target network node 415 (e.g., including synchronization with the target network node 415) while continuing to communicate with the source network node 410. For example, while the UE 405 is performing the random access procedure with the target network node 415, the UE 405 may transmit uplink data, uplink control information, and/or an uplink reference signal (e.g., a sounding reference signal (SRS)) to the source network node 410, and/or may receive downlink data, downlink control information (DCI), and/or a downlink reference signal from the source network node 410.

As shown by reference number 465, upon successfully establishing a connection with the target network node 415 (e.g., via a random access procedure) during the handover execution phase 435, the UE 405 may transmit an RRC reconfiguration completion message to the target network node 415. Reception of the RRC reconfiguration message by the target network node 415 may trigger the start of the handover completion phase 440.

As shown by reference number 470, during the handover completion phase 440, the source network node 410 and the target network node 415 may communicate with one another to prepare for release of the connection between the source network node 410 and the UE 405. In some aspects, the target network node 415 may determine that a connection between the source network node 410 and the UE 405 is to be released, such as after receiving the RRC reconfiguration message from the UE 405. In this case, the target network node 415 may transmit a handover connection setup completion message to the source network node 410. The handover connection setup completion message may cause the source network node 410 to stop transmitting data to the UE 405 and/or to stop receiving data from the UE 405. Additionally, or alternatively, the handover connection setup completion message may cause the source network node 410 to forward communications associated with the UE 405 to the target network node 415 and/or to notify the target network node 415 of a status of one or more communications with the UE 405. For example, the source network node 410 may forward, to the target network node 415, buffered downlink communications (e.g., downlink data) for the UE 405 and/or uplink communications (e.g., uplink data) received from the UE 405. Additionally, or alternatively, the source network node 410 may notify the target network node 415 regarding a PDCP status associated with the UE 405 and/or a sequence number to be used for a downlink communication with the UE 405.

As shown by reference number 475, during the handover completion phase 440, the target network node 415 may transmit an RRC reconfiguration message to the UE 405 to instruct the UE 405 to release the connection with the source network node 410. Upon receiving the instruction to release the connection with the source network node 410, the UE 405 may stop communicating with the source network node 410. For example, the UE 405 may refrain from transmitting uplink communications to the source network node 410 and/or may refrain from monitoring for downlink communications from the source network node 410.

As shown by reference number 480, during the handover completion phase 440, the UE may transmit an RRC reconfiguration completion message to the target network node 415 to indicate that the connection between the source network node 410 and the UE 405 is being released or has been released.

As shown by reference number 485, during the handover completion phase 440, the target network node 415, the UPF device 420, and/or the AMF device 425 may communicate to switch a user plane path of the UE 405 from the source network node 410 to the target network node 415. Prior to switching the user plane path, downlink communications for the UE 405 may be routed through the core network to the source network node 410. After the user plane path is switched, downlink communications for the UE 405 may be routed through the core network to the target network node 415. Upon completing the switch of the user plane path, the AMF device 425 may transmit an end marker message to the source network node 410 to signal completion of the user plane path switch. As shown by reference number 490, the target network node 415 and the source network node 410 may communicate to release the source network node 410.

As part of the MBB handover procedure, the UE 405 may maintain simultaneous connections with the source network node 410 and the target network node 415 during a time period 495. The time period 495 may start at the beginning of the handover execution phase 435 (e.g., upon reception by the UE 405 of a handover command from the source network node 410) when the UE 405 performs a random access procedure with the target network node 415. The time period 495 may end upon release of the connection between the UE 405 and the source network node 410 (e.g., upon reception by the UE 405 of an instruction, from the target network node 415, to release the source network node 410). By maintaining simultaneous connections with the source network node 410 and the target network node 415, the handover procedure can be performed with zero or a minimal interruption to communications, thereby reducing latency.

As indicated above, FIG. 4 is provided as an example. Other examples may differ from what is described with regard to FIG. 4.

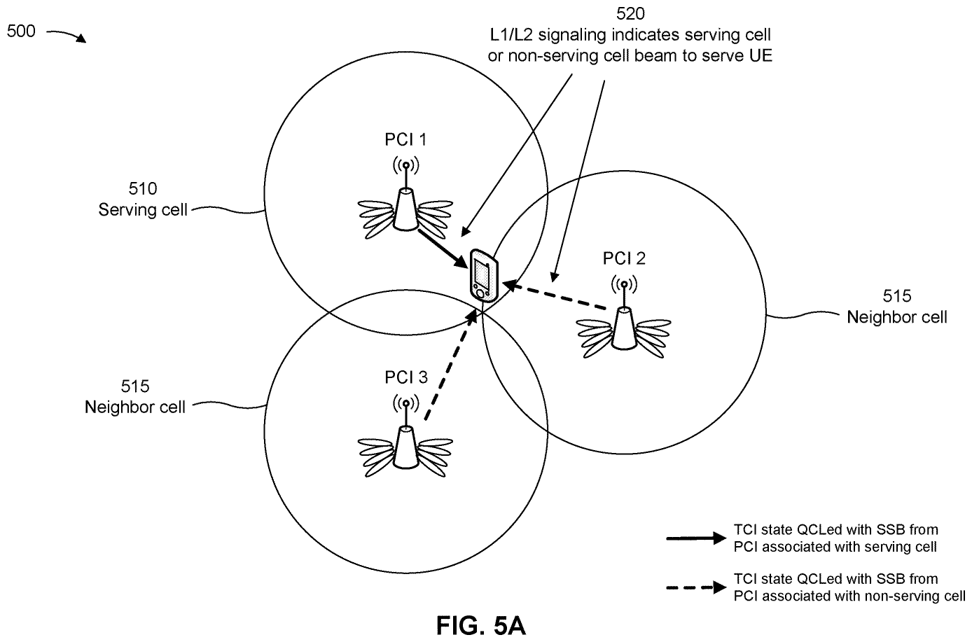

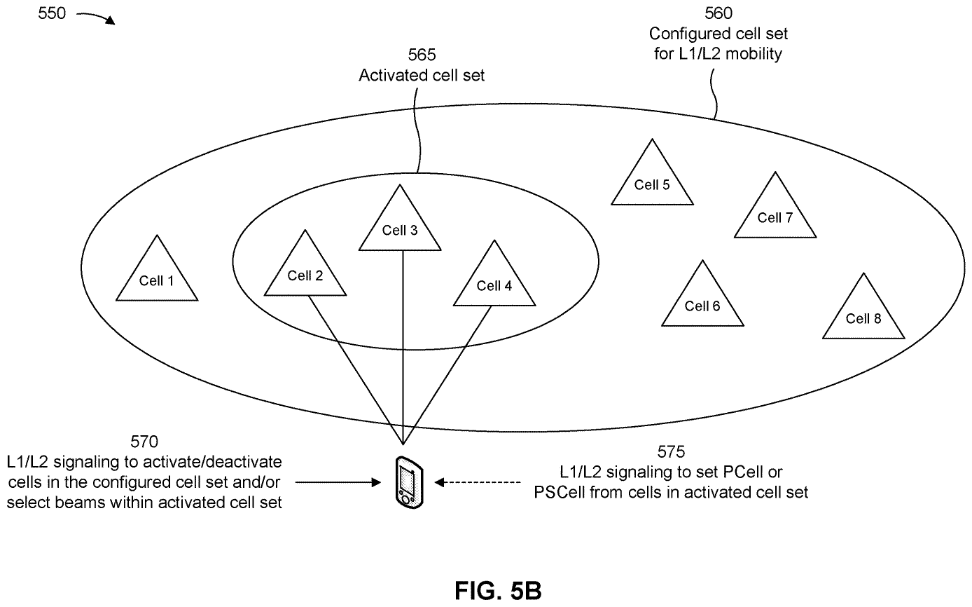

FIGS. 5A-5B are diagrams illustrating examples 500, 550 of L1/L2 inter-cell mobility, in accordance with the present disclosure.

In a wireless network, a UE and a network node may communicate on an access link using directional links (e.g., using high-dimensional phased arrays) to benefit from a beamforming gain and/or to maintain acceptable communication quality. The directional links, however, typically require fine alignment of transmit and receive beams, which may be achieved through a set of operations referred to as beam management and/or beam selection, among other examples. Further, a wireless network may support multi-beam operation at relatively high carrier frequencies (e.g., within FR2 or FR4), which may be associated with harsher propagation conditions than comparatively lower carrier frequencies. For example, relative to a sub-6 gigahertz (GHz) band (e.g., FR1), signals propagating in a millimeter wave frequency band may suffer from increased pathloss and severe channel intermittency, and/or may be blocked by objects commonly present in an environment surrounding the UE (e.g., a building, a tree, and/or a body of a user, among other examples). Accordingly, beam management is particularly important for multi-beam operation in a relatively high carrier frequency.

One possible enhancement for multi-beam operation at higher carrier frequencies is facilitation of efficient (e.g., low latency and low overhead) downlink and/or uplink beam management to support higher L1/L2-centric inter-cell mobility. Accordingly, one goal for L1/L2-centric inter-cell mobility is to enable a UE to perform a cell switch via dynamic control signaling at lower layers (e.g., DCI for L1 signaling or a MAC control element (MAC-CE) for L2 signaling) rather than semi-static Layer 3 (L3) RRC signaling to reduce latency, reduce overhead, and/or otherwise increase efficiency of the cell switch.

For example, FIG. 5A illustrates an example 500 of a first L1/L2 inter-cell mobility technique, which may be referred to as beam-based inter-cell mobility, dynamic point selection based inter-cell mobility, and/or non-serving cell-based inter-cell mobility, among other examples. As described in further detail herein, the first L1/L2 inter-cell mobility technique may enable a network node to use L1 signaling (e.g., DCI) or L2 signaling (e.g., a MAC-CE) to indicate that a UE is to communicate on an access link using a beam from a serving cell or a non-serving cell. For example, in a wireless network where L1/L2 inter-cell mobility is not supported (e.g., cell switches are triggered only by an L3 handover), beam selection for control information and for data is typically limited to beams within a physical cell identity (PCI) associated with a serving cell. In contrast, in a wireless network that supports the first L1/L2 inter-cell mobility technique (e.g., as shown in FIG. 5A), beam selection for control and data may be expanded to include any beams within a serving cell 510 or one or more non-serving neighbor cells 515 configured for L1/L2 inter-cell mobility.

For example, in the first L1/L2 inter-cell mobility technique shown in FIG. 5A, a UE may be configured with a single serving cell 510, and may be further configured with a neighbor cell set that includes one or more non-serving cells 515 configured for L1/L2 inter-cell mobility. In general, the serving cell 510 and the non-serving cell(s) 515 configured for L1/L2 inter-cell mobility may be associated with a common CU and a common DU, or the serving cell 510 and the non-serving cell(s) 515 configured for L1/L2 inter-cell mobility may be associated with a common CU and different DUs. In some aspects, as shown by reference number 520, a network node may trigger L1/L2 inter-cell mobility for a UE using L1/L2 signaling (e.g., DCI or a MAC-CE) that indicates a selected transmission configuration indication (TCI) state quasi co-located (QCLed) with a reference signal (e.g., a synchronization signal block (SSB)) associated with a PCI. For example, in FIG. 5A, the UE may be communicating with the serving cell 510 using a TCI state that is QCLed with an SSB from a PCI associated with the serving cell 510 (e.g., shown as PCI 1 in FIG. 5A), and L1/L2 signaling may trigger inter-cell mobility by indicating that the UE is to switch to communicating using a TCI state that is QCLed with an SSB from a PCI associated with a non-serving neighbor cell 515 (e.g., shown as PCI 2 in FIG. 5A). Accordingly, in the first L1/L2 inter-cell mobility technique, the network node (e.g., the common CU controlling the serving cell 510 and the non-serving neighbor cell(s) 415) may use L1/L2 signaling to select a beam from either the serving cell 510 or a non-serving neighbor cell 515 to serve the UE.

In this way, relative to restricting L1/L2 beam selection to beams within the serving cell 510, the first L1/L2 inter-cell mobility technique may be more robust against blocking and may provide more opportunities for higher rank spatial division multiplexing across different cells. However, the first L1/L2 inter-cell mobility technique does not enable support for changing a special cell (SpCell) for a UE, where an SpCell may be a primary cell (PCell) or a primary secondary cell (PSCell). Rather, in the first L1/L2 inter-cell mobility technique, triggering an SpCell change is performed via a legacy L3 handover using RRC signaling. In this respect, the first L1/L2 inter-cell mobility technique is associated with a limitation in that L1/L2 signaling can only be used to indicate a beam from the serving cell 510 or a configured neighbor cell 515 while the UE is in the coverage area of the serving cell 510 (e.g., because L1/L2 signaling cannot be used to change the PCell or PSCell). Accordingly, FIG. 5B illustrates an example 550 of a second L1/L2 inter-cell mobility technique, which may be referred to as serving cell-based inter-cell mobility, among other examples. As described in further detail herein, the second L1/L2 inter-cell mobility technique may enable a network node to use L1/L2 signaling (e.g., DCI or a MAC-CE) to indicate control information associated with an activated cell set and/or a deactivated cell set and/or to indicate a change to an SpCell within the activated cell set.

For example, as shown in FIG. 5B, the second L1/L2 inter-cell mobility technique may use mechanisms that are generally similar to carrier aggregation to enable L1/L2 inter-cell mobility, except that different cells configured for L1/L2 inter-cell mobility may be on the same carrier frequency. As shown in FIG. 5B, a network node may configure a cell set 560 for L1/L2 inter-cell mobility (e.g., using RRC signaling). As further shown, an activated cell set 565 may include one or more cells in the configured cell set 560 that are activated and ready to use for data and/or control transfer. Accordingly, in the second L1/L2 inter-cell mobility technique, a deactivated cell set may include one or more cells that are included in the cell set 560 configured for L1/L2 inter-cell mobility but are not included in the activated cell set 565. However, the cells that are included in the deactivated cell set can be readily activated, and thereby added to the activated cell set 565, using L1/L2 signaling. Accordingly, as shown by reference number 570, L1/L2 signaling can be used for mobility management of the activated cell set 565. For example, in some aspects, L1/L2 signaling can be used to activate cells within the configured cell set 560 (e.g., to add cells to the activated cell set 565), to deactivate cells in the activated cell set 565, and/or to select beams within the cells included in the activated cell set 565. In this way, the second L1/L2 inter-cell mobility technique may enable seamless mobility among the cells included in the activated cell set 565 using L1/L2 signaling (e.g., using beam management techniques).

Furthermore, as shown by reference number 575, the second L1/L2 inter-cell mobility technique enables using L1/L2 signaling to set or change an SpCell (e.g., a PCell or PSCell) from the cells included in the activated cell set 565. Additionally, or alternatively, when the cell to become the new SpCell is in the deactivated cell set (e.g., is included in the cell set 560 configured for L1/L2 mobility but not the activated cell set 565), L1/L2 signaling can be used to move the cell from the deactivated cell set to the activated cell set 565 before further L1/L2 signaling is used to set the cell as the new SpCell. However, in the second L1/L2 inter-cell mobility technique, an L3 handover (e.g., using RRC signaling) is used to change the SpCell when the new SpCell is not included in the cell set 560 configured for L1/L2 inter-cell mobility. In such cases, RRC signaling associated with the L3 handover may be used to update the cells included in the cell set 560 configured for L1/L2 inter-cell mobility. Accordingly, L1/L2 inter-cell mobility can provide more efficient cell switching to support multi-beam operation, enabling lower latency and reduced overhead by using L1 signaling (e.g., DCI) and/or L2 signaling (e.g., a MAC-CE) rather than L3 signaling (e.g., RRC) to change the beam(s) that a UE uses to communicate over an access link.

As indicated above, FIGS. 5A-5B are provided as examples. Other examples may differ from what is described with regard to FIGS. 5A-5B.

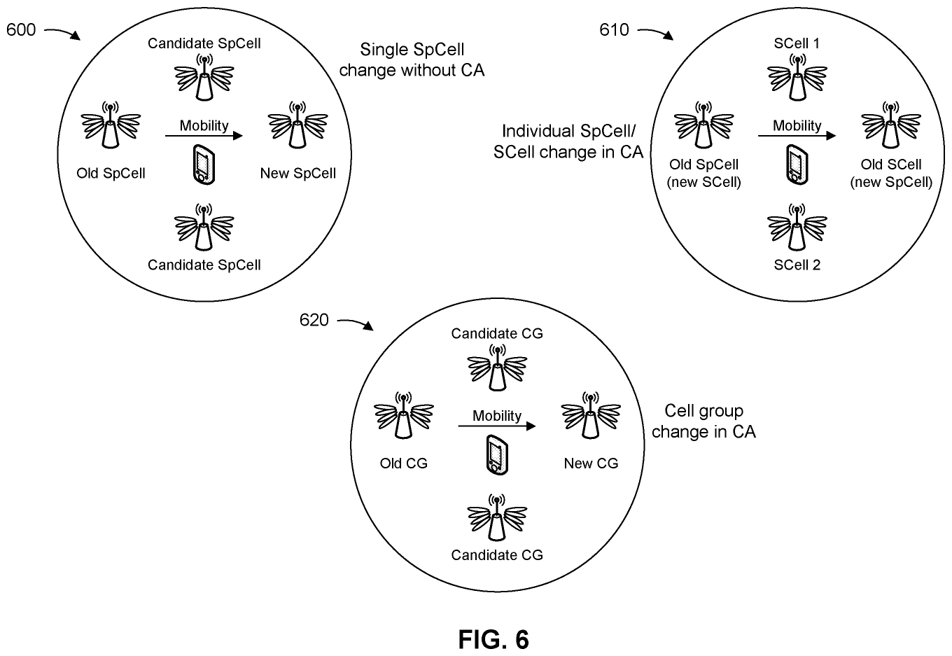

FIG. 6 is a diagram illustrating examples 600, 610, 620 of a cell update in L1/L2 inter-cell mobility scenarios, in accordance with the present disclosure. As shown in FIG. 6, examples 600, 610, 620 include communication between a UE (e.g., UE 120 or UE 405) and one or more network nodes (e.g., one or more networks nodes that provide a source cell and/or a target cell in an inter-cell mobility scenario, such as network node 110, network node 410, network node 415, or the like). In some aspects, the UE and the network node(s) may communicate in a wireless network, such as wireless network 100. The UE and the network node(s) may communicate via a wireless access link, which may include an uplink and a downlink. Furthermore, as described herein, the wireless network in which the UE and the network node(s) communicate may support one or more L1/L2 inter-cell mobility techniques. For example, the wireless network may support the beam-based or non-serving cell-based L1/L2 inter-cell mobility technique described above with reference to FIG. 5A, the serving cell-based L1/L2 inter-cell mobility technique described above with reference to FIG. 5B, or a combination thereof.

In some aspects, as described herein, examples 600, 610, 620 relate to different scenarios in which L1 signaling (e.g., a DCI message) or L2 signaling (e.g., a MAC-CE) is used to indicate a change to a serving cell or a serving cell group (e.g., changing from a source cell to a target cell). For example, as described in further detail herein, examples 600, 610, 620 generally relate to different scenarios in which L1/L2 signaling may be used to dynamically switch among candidate serving cells (e.g., including a special cell (SpCell), which may be a PCell or a PSCell, and/or an SCell).

As shown in FIG. 6, and by example 600, a network node may configure the UE with a candidate SpCell set that includes various candidate SpCells to enable individual SpCell selection in a first L1/L2 inter-cell mobility scenario where separate signaling is used to indicate a SpCell change without carrier aggregation or dual connectivity. For example, the UE may be communicating with a source SpCell (shown as an old SpCell), and the serving SpCell may be switched to a target SpCell (shown as a new SpCell) that corresponds to a candidate SpCell included in the candidate SpCell set. Accordingly, in example 600, L1/L2 signaling may be used to select a single SpCell among various candidate SpCells in a preconfigured candidate SpCell set without carrier aggregation or dual connectivity (e.g., the candidate SpCell set does not include any SCells). In this case, the new SpCell may be selected based on a beam indication, and selection of an SCell may be based on legacy (e.g., L3) signaling or separate L1/L2 signaling. Additionally, or alternatively, as shown by example 610, the UE may be configured with a candidate SpCell set, and a SpCell may be changed from a source cell to a target cell by swapping roles of a SpCell and an SCell among the cells included in the candidate SpCell set (e.g., in a carrier aggregation or dual connectivity scenario). For example, as shown by example 610 in FIG. 6, a current SpCell may be swapped with a current SCell such that the old SpCell becomes a new SCell and the old SCell becomes the new SpCell. Additionally, or alternatively, as shown by example 620, the UE may be configured with a candidate cell group, which may enable an SpCell (e.g., a PCell or a PSCell) and an SCell to be switched together in a carrier aggregation or dual connectivity scenario. For example, in this case, a cell group including multiple cells can be activated or deactivated together using L1/L2 signaling, where a current serving cell may be selected from a current cell group and the current serving cell may be selected from a new cell group based on mobility of the UE. In this case, the L1/L2 signaling used to change the cell group may be similar to examples 600 and 610, except that the L1/L2 signaling is used to switch cell groups that may include multiple cells rather than individual cells.

In general, in examples 600, 610, 620, the L1/L2 signaling that is used to switch the serving cell for the UE may be based on one or more L1 measurements that are obtained and reported by the UE. For example, a network node may configure the UE to obtain an L1-RSRP measurement, an L1-RSRQ measurement, an L1-SINR measurement, and/or other suitable intra-frequency and/or inter-frequency measurements for one or more candidate cells (e.g., target cells, candidate SpCells and/or candidate SCells), and the UE may transmit an L1 report that includes the L1 measurements to the network node to enable L1/L2 inter-cell mobility. However, current wireless communication standards and/or protocols are unclear with respect to how L1 measurements for candidate cells are to be configured and reported for L1/L2 mobility. Accordingly, some aspects described herein relate to techniques to configure L1 measurements and L1 reporting for candidate cells to support L1/L2 mobility. In this way, some aspects described herein may be used to configure L1 measurements and L1 reporting for candidate cells such that L1 measurements can be used to trigger inter-cell mobility using L1 signaling (e.g., DCI) and/or L2 signaling (e.g., a MAC-CE), which may reduce a handover latency and offer other potential advantages, as discussed above.

As indicated above, FIG. 6 is provided as an example. Other examples may differ from what is described with regard to FIG. 6.

FIGS. 7A-7C are diagrams illustrating examples 700 associated with a CSI measurement configuration for a candidate cell in L1/L2 mobility, in accordance with the present disclosure. As shown in FIG. 7A, examples 700 includes communication between a UE (e.g., UE 120 or UE 405) and one or more network nodes (e.g., one or more networks nodes that provide an active cell and/or a candidate cell in an inter-cell mobility scenario, such as network node 110, network node 410, network node 415, or the like). In some aspects, the UE and the network node(s) may communicate in a wireless network, such as wireless network 100. The UE and the network node(s) may communicate via a wireless access link, which may include an uplink and a downlink. Furthermore, as described herein, the wireless network in which the UE and the network node(s) communicate may support one or more L1/L2 inter-cell mobility techniques.

As shown in FIG. 7A, and by reference number 710, the UE may transmit, to the network node that provides the active serving cell for the UE, information that relates to a capability of the UE to obtain L1 measurements and/or report L1 measurements for one or more candidate cells. For example, in some aspects, the UE capability information may indicate a maximum number of additional cells or candidate cells (e.g., other than the active cell) that the UE supports for inter-cell beam management. For example, in some aspects, the UE capability may indicate a maximum number of additional cells or candidate cells that the UE supports for intra-frequency beam management and/or maximum number of additional cells or candidate cells that the UE supports for inter-frequency beam management, which may have the same value or different values (e.g., up to seven (7) candidate cells for intra-frequency inter-cell beam management or up to eight (8) candidate cells for inter-frequency inter-cell beam management). Additionally, or alternatively, the UE capability information may indicate a maximum number of channel measurement resource (CMR) and/or interference measurement resource (IMR) reference signals supported by the UE for each candidate cell that can be configured for L1 measurements. For example, in some aspects, the UE capability may indicate a maximum number of CMR and/or IMR reference signals that the UE can measure from a candidate cell for intra-frequency and/or inter-frequency beam management, which may have the same value or different values (e.g., up to sixty-four (64) CMR and/or IMR reference signals for intra-frequency inter-cell beam management or up to thirty-two (32) CMR and/or IMR reference signals for inter-frequency inter-cell beam management). Additionally, or alternatively, the UE capability information may indicate whether the UE supports reporting an L1-SINR measurement for one or more candidate cells.

As further shown in FIG. 7A, and by reference number 720, the network node that provides the active cell for the UE may transmit, and the UE may receive, an L1 measurement configuration for the active cell and one or more candidate cells. For example, as described herein, the L1 measurement configuration may be based at least in part on the information related to the capability of the UE for obtaining and/or reporting L1 measurements (e.g., dependent on the maximum number of candidate cells, the maximum number of CMR reference signals, the maximum number of IMR reference signals, and/or L1-SINR measurements supported by the UE). Accordingly, as described herein, the L1 measurement configuration may enable the UE to obtain L1 measurements for one or more candidate cells to support inter-cell mobility that may be triggered by L1/L2 signaling (e.g., DCI and/or a MAC-CE).

For example, referring to FIG. 7B, reference number 722 depicts an example where the L1 measurement configuration for a candidate cell may be configured on an active cell, and the L1 measurement configuration includes a CSI measurement configuration for both the active cell and one or more candidate cells. For example, as shown, a serving cell configuration (e.g., indicated in a ServingCellConfig parameter) associated with the active cell may include a CSI measurement configuration, and the CSI measurement configuration may configure an intra-frequency reference signal for the active cell and an intra-frequency or inter-frequency reference signal for the one or more candidate cells. For example, as shown, a serving cell configuration for the active cell includes a CSI measurement configuration (e.g., configuring a CMR for an L1-RSRP or L1-RSRQ measurement, or a CMR and an IMR for an L1-SINR measurement), and the CSI measurement configuration associated with the active cell may include an intra-frequency reference signal configuration for the active cell and an intra-frequency or inter-frequency reference signal configuration for the one or more candidate cells. In some aspects, in cases where the CSI measurement configuration indicates one or more inter-frequency reference signals, the CSI measurement configuration for a non-serving (e.g., candidate) cell may include frequency information and/or an SSB measurement timing configuration (SMTC) window or measurement gap (MG) during which the UE is to obtain L1 measurements from the corresponding candidate cell(s). Based on the CSI measurement configuration, the UE may be scheduled with an L1 measurement report on uplink control information (UCI) for mobility triggered by L1/L2 signaling. For example, an L1 measurement report for one or more candidate cells may be transmitted as a semi-persistent report on a PUSCH and/or an aperiodic report on a PUSCH. Furthermore, in a single report instance, an L1 measurement report may include intra-frequency and/or inter-frequency measurements for a serving cell and one or more candidate cells.

Alternatively, still referring to FIG. 7B, reference number 724 depicts an example where the L1 measurement configuration for a candidate cell may be configured on an active cell, and the L1 measurement configuration includes independent CSI measurement configurations for the active cell and the candidate cell. For example, as shown, a serving cell configuration associated with the active cell may include a first CSI measurement configuration that configures an intra-frequency reference signal for the active cell and a second CSI measurement configuration that configures an inter-frequency reference signal for at least one candidate cell. In this case, an independent CSI measurement configuration may be provided on the active serving cell for the at least one candidate cell, where the independent CSI measurement configuration(s) for candidate cell(s) are decoupled from the L1 measurement configuration for the active cell. For example, in cases where independent CMR reference signals are configured in the active cell and the at least one candidate cell, the L1 measurement resource set may be configured separately from configurations associated with the candidate cell(s) (e.g., in a ServingCellConfig and/or CellGroupConfig parameter).

Alternatively, still referring to FIG. 7B, reference number 726 depicts an example where an L1 measurement configuration for a candidate cell is configured separately from an L1 measurement configuration for an active cell. For example, as shown, a first serving cell configuration associated with the active cell may include a first CSI measurement configuration that configures an intra-frequency reference signal for the active cell, and a second serving cell configuration associated with a candidate cell may include a second CSI measurement configuration that configures an intra-frequency or inter-frequency reference signal for the candidate cell. In this case, CSI measurement configurations may be separately provided for the active serving cell and the candidate cell, where the L1 measurement resource for the candidate cell set may be configured inside or within the configuration(s) associated with the candidate cell(s) (e.g., in a ServingCellConfig and/or CellGroupConfig parameter). In some aspects, the L1 measurement configuration for each candidate cell may be configured separately from any L1 measurement configuration for an active cell. CSI measurement configurations may be separately provided for the active serving cell and each candidate cell, where the L1 measurement resource for each candidate cell set may be configured inside or within the configuration(s) associated with the candidate cell(s) (e.g., in a ServingCellConfig and/or CellGroupConfig parameter).

Alternatively, still referring to FIG. 7B, reference number 728 depicts an example where the L1 measurement configuration for an active cell does not include reference signal information or cell information for the L1 measurements to be obtained by the UE. Instead, as shown, the serving cell configuration associated with the active cell includes a CSI measurement configuration that configures an SMTC window for L1-based measurements of one or more SSBs, in which case the UE may measure one or more intra-frequency SSB transmissions from the active cell and/or one or more intra-frequency or inter-frequency SSB transmissions from one or more candidate cells during the SMTC window. For example, as described herein, the UE may measure one or more SSBs that are detected during the SMTC window and may identify one or more PCIs associated with the one or more SSBs that are detected during the SMTC window, which may then be reported to the network node associated with the active serving cell. In some aspects, for the intra-frequency measurements associated with the active serving cell, the CSI measurement configuration included in the serving cell configuration includes neither SSB or reference signal indexes nor PCI information, and the UE may search PCIs for SSB transmissions that are detected during the SMTC window. Additionally, or alternatively, for the inter-frequency measurements associated with the candidate serving cells, the CSI measurement configuration included in the serving cell configuration includes neither SSB or reference signal indexes nor PCI information, but frequency information for the candidate cells is configured, whereby the UE may use the frequency information to search PCIs for SSB transmissions that are detected during the SMTC window.

Referring again to FIG. 7A, as shown by reference number 730, the network node that provides the active cell for the UE may transmit, and the UE may receive, an L1 report configuration for the active cell and one or more candidate cells. For example, as described herein, the L1 report configuration may be based at least in part on the information related to the capability of the UE for reporting L1 measurements (e.g., dependent on the maximum number of candidate cells, the maximum number of CMR reference signals, the maximum number of IMR reference signals, and/or measurements that the UE is capable of reporting in an L1 measurement report),

For example, referring to FIG. 7C, reference number 732 depicts an example where the L1 report configuration for a candidate cell may be configured on an active cell, and the L1 report configuration includes a CSI report configuration for both the active cell and one or more candidate cells. For example, as shown, a serving cell report configuration (e.g., indicated in a ServingCellConfig parameter) associated with the active cell may include a CSI report configuration, and the CSI report configuration may configure a CSI report for the active cell and a CSI report for the candidate cell. For example, as shown, a serving cell configuration for the active cell includes a CSI report configuration, and the CSI report configuration associated with the active cell may include a first CSI report configuration for the active cell and a second CSI report configuration for the candidate cell.

Alternatively, still referring to FIG. 7C, reference number 734 depicts an example where the L1 report configuration for a candidate cell may be configured on an active cell, and the L1 report configuration includes independent CSI report configurations for the active cell and the candidate cell. For example, as shown, a serving cell configuration associated with the active cell may include a first CSI report configuration that configures a first CSI report for the active cell and a second CSI report configuration that configures a second CSI report for the candidate cell. In this case, an independent CSI report configuration may be provided on the active serving cell for a candidate cell, where the independent CSI report configuration(s) for the candidate cell is decoupled from the L1 report configuration for the active cell. For example, in cases where independent CSI reports are configured in the active cell and the candidate cell, the L1 measurement report may be configured separately from configurations associated with the candidate cell(s) (e.g., in a ServingCellConfig and/or CellGroupConfig parameter).

Alternatively, still referring to FIG. 7C, reference number 736 depicts an example where an L1 report configuration for a candidate cell is configured separately from an L1 report configuration for an active cell. For example, as shown, a first serving cell configuration associated with the active cell may include a first CSI report configuration that configures a first CSI report for the active cell, and a second serving cell configuration associated with a candidate cell may include a second CSI report configuration that configures a second CSI report for the candidate cell. In this case, CSI report configurations may be separately provided for the active serving cell and the candidate cell, where the L1 report for the candidate cell set may be configured inside or within the configuration(s) associated with the candidate cell(s) (e.g., in a ServingCellConfig and/or CellGroupConfig parameter). In some aspects, the L1 report configuration for each candidate cell may be configured separately from any L1 report configuration for an active cell. CSI report configurations may be separately provided for the active serving cell and each candidate cell, where the L1 report for each candidate cell set may be configured inside or within the configuration(s) associated with the candidate cell(s) (e.g., in a ServingCellConfig and/or CellGroupConfig parameter).

Alternatively, in some aspects, the L1 report configuration provided by the network node associated with the active cell may not include any L1 report configuration for candidate cells. In this case, the L1 measurement report including the L1 measurements for candidate cells may be carried in a MAC-CE.

In some aspects, referring again to FIG. 7A, as shown by reference number 740, the UE may obtain one or more L1 measurements for a candidate cell based on the L1 measurement configuration provided by the network node associated with the active cell. For example, in cases where the L1 measurement configuration indicates one or more CMR reference signals, the UE may monitor and/or measure the one or more CMR reference signals from the candidate cell to obtain L1 measurements for the candidate cell, such as an L1-RSRP measurement and/or an L1-RSRQ measurement, among other examples. Additionally, or alternatively, in cases where the UE supports an L1-SINR measurement that is used as a beam metric in L1/L2 inter-cell mobility, the L1 measurement configuration provided by the network node associated with the active cell may indicate an IMR reference signal in addition to the CMR reference signal. For example, in an L1-SINR measurement, the UE may be configured to measure the CMR reference signal to determine the “signal” component of the L1-SINR measurement, and may measure the IMR reference signal to determine the “interference” and/or “interference-plus-noise” component of the L1-SINR measurement. In such cases, the CMR reference signal may include a non-zero power (NZP) CSI reference signal (CSI-RS) (NZP CSI-RS), and the IMR reference signal may include the same NZP CSI-RS as the CMR reference signal, a different NZP CSI-RS, or a zero-power (ZP) CSI-RS. Additionally, or alternatively, the CMR reference signal may include an SSB, and the IMR reference signal may include a ZP CSI-RS or an NZP CSI-RS. In any case, as shown by reference number 750, the UE may transmit, to the network node associated with the active cell, an L1 measurement report that includes the L1 measurements associated with the candidate cell, and the active cell may use the L1 measurements carried in the L1 measurement report to determine whether to trigger L1 or L2 mobility for the UE (e.g., transmitting DCI or a MAC-CE to the UE to trigger a handover to a candidate cell in cases where the L1 measurements carried in the L1 measurement report satisfy one or more conditions).

As indicated above, FIGS. 7A-7C are provided as examples. Other examples may differ from what is described with regard to FIGS. 7A-7C.

FIG. 8 is a diagram illustrating an example process 800 performed, for example, by a UE, in accordance with the present disclosure. Example process 800 is an example where the UE (e.g., UE 120) performs operations associated with CSI measurement configuration for a candidate cell in L1/L2 mobility.

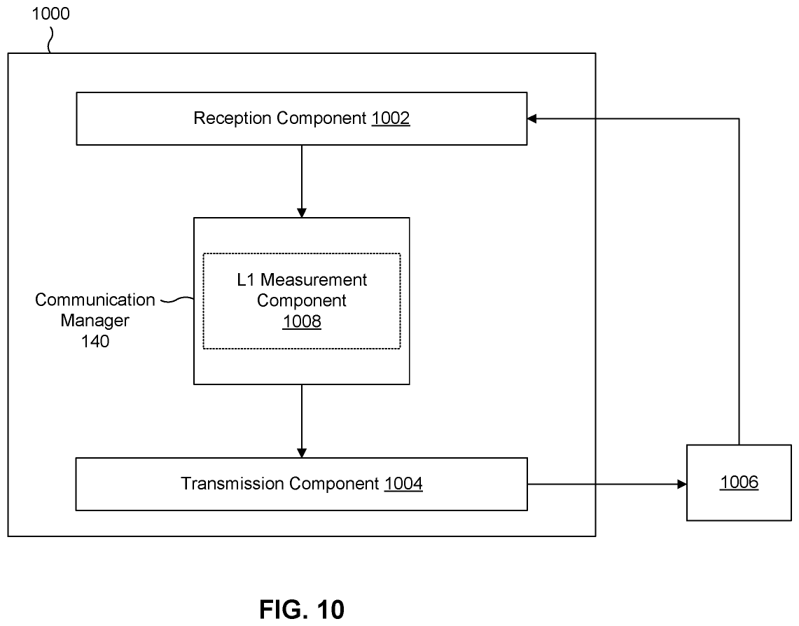

As shown in FIG. 8, in some aspects, process 800 may include receiving, from a network node, a CSI measurement configuration configuring one or more L1 measurements for a candidate cell (block 810). For example, the UE (e.g., using communication manager 140 and/or reception component 1002, depicted in FIG. 10) may receive, from a network node, a CSI measurement configuration configuring one or more L1 measurements for a candidate cell, as described above.

As further shown in FIG. 8, in some aspects, process 800 may include obtaining the one or more L1 measurements for the candidate cell based at least in part on the CSI measurement configuration (block 820). For example, the UE (e.g., using communication manager 140 and/or L1 measurement component 1008, depicted in FIG. 10) may obtain the one or more L1 measurements for the candidate cell based at least in part on the CSI measurement configuration, as described above.

As further shown in FIG. 8, in some aspects, process 800 may include transmitting, to the network node, an L1 measurement report that indicates the one or more L1 measurements for the candidate cell (block 830). For example, the UE (e.g., using communication manager 140 and/or transmission component 1004, depicted in FIG. 10) may transmit, to the network node, an L1 measurement report that indicates the one or more L1 measurements for the candidate cell, as described above.

Process 800 may include additional aspects, such as any single aspect or any combination of aspects described below and/or in connection with one or more other processes described elsewhere herein.

In a first aspect, the CSI measurement configuration is included in a serving cell configuration associated with an active serving cell.

In a second aspect, alone or in combination with the first aspect, the CSI measurement configuration configures one or more L1 measurements for the active serving cell.

In a third aspect, alone or in combination with one or more of the first and second aspects, the CSI measurement configuration is a first CSI measurement configuration that is independent from a second CSI measurement configuration configuring one or more L1 measurements for the active serving cell.

In a fourth aspect, alone or in combination with one or more of the first through third aspects, the CSI measurement configuration is included in a serving cell configuration associated with the candidate cell.

In a fifth aspect, alone or in combination with one or more of the first through fourth aspects, the CSI measurement configuration indicates a CMR for the candidate cell.

In a sixth aspect, alone or in combination with one or more of the first through fifth aspects, the CSI measurement configuration indicates an SMTC window for obtaining the one or more L1 measurements from one or more SSBs.

In a seventh aspect, alone or in combination with one or more of the first through sixth aspects, the L1 measurement report includes one or more SSB indexes and one or more PCIs associated with the one or more SSBs from which the one or more L1 measurements are obtained during the SMTC window.

In an eighth aspect, alone or in combination with one or more of the first through seventh aspects, the CSI measurement configuration indicates frequency information for obtaining the one or more L1 measurements from one or more inter-frequency SSBs.

In a ninth aspect, alone or in combination with one or more of the first through eighth aspects, process 800 includes receiving, from the network node, a CSI report configuration for reporting the one or more L1 measurements for the candidate cell, wherein the L1 measurement report is associated with the CSI report configuration.

In a tenth aspect, alone or in combination with one or more of the first through ninth aspects, the CSI report configuration is included in a serving cell configuration associated with an active serving cell.

In an eleventh aspect, alone or in combination with one or more of the first through tenth aspects, the CSI report configuration configures a CSI report for the active serving cell.

In a twelfth aspect, alone or in combination with one or more of the first through eleventh aspects, the CSI report configuration is a first CSI report configuration that is independent from a second CSI report configuration for reporting one or more L1 measurements for the active serving cell.

In a thirteenth aspect, alone or in combination with one or more of the first through twelfth aspects, the CSI report configuration is included in a serving cell configuration associated with the candidate cell.

In a fourteenth aspect, alone or in combination with one or more of the first through thirteenth aspects, the L1 measurement report that indicates the one or more L1 measurements for the candidate cell is included in a MAC-CE.

In a fifteenth aspect, alone or in combination with one or more of the first through fourteenth aspects, the CSI measurement configuration indicates a CMR and an IMR for the candidate cell based at least in part on the one or more L1 measurements including an L1-SINR.

In a sixteenth aspect, alone or in combination with one or more of the first through fifteenth aspects, the CMR is a first NZP CSI-RS, and the IMR is the first NZP CSI-RS, a second NZP CSI-RS, or a ZP CSI-RS.

In a seventeenth aspect, alone or in combination with one or more of the first through sixteenth aspects, the CMR is a SSB, and the IMR is a ZP CSI-RS or an NZP CSI-RS.

In an eighteenth aspect, alone or in combination with one or more of the first through seventeenth aspects, process 800 includes transmitting, to the network node, UE capability information related to a capability to obtain the one or more L1 measurements for the candidate cell, wherein the CSI measurement configuration is based at least in part on the UE capability information.

In a nineteenth aspect, alone or in combination with one or more of the first through eighteenth aspects, the UE capability information indicates a maximum number of candidate cells supported by the UE.

In a twentieth aspect, alone or in combination with one or more of the first through nineteenth aspects, the UE capability information indicates a maximum number of CMR reference signals supported by the UE per candidate cell.

In a twenty-first aspect, alone or in combination with one or more of the first through twentieth aspects, the UE capability information indicates a maximum number of IMR reference signals supported by the UE per candidate cell.

In a twenty-second aspect, alone or in combination with one or more of the first through twenty-first aspects, the UE capability information indicates whether the UE supports reporting an L1-SINR for the candidate cell.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with CSI measurement configuration for a candidate cell in L1/L2 mobility.

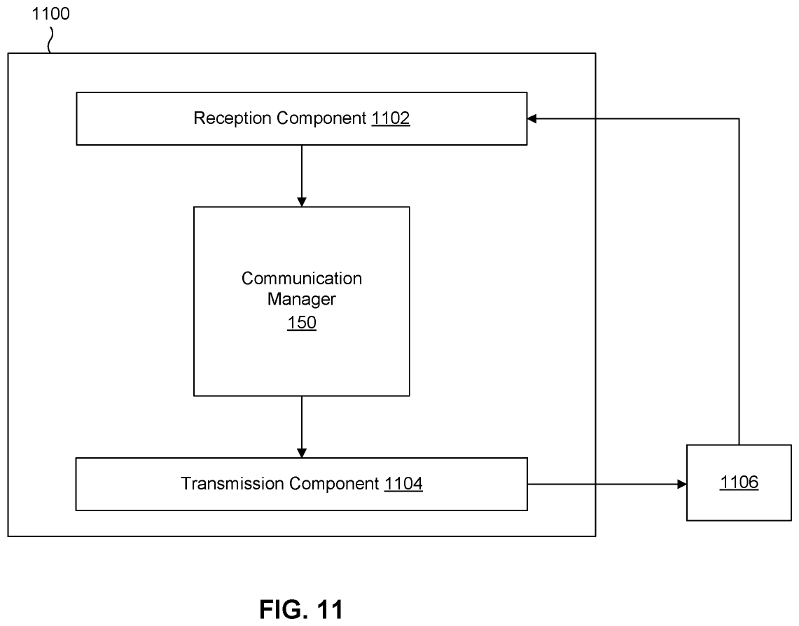

As shown in FIG. 9, in some aspects, process 900 may include transmitting, to a UE, a CSI measurement configuration configuring one or more L1 measurements for a candidate cell (block 910). For example, the network node (e.g., using communication manager 150 and/or transmission component 1104, depicted in FIG. 11) may transmit, to a UE, a CSI measurement configuration configuring one or more L1 measurements for a candidate cell, as described above.

As further shown in FIG. 9, in some aspects, process 900 may include receiving, from the UE, an L1 measurement report that indicates the one or more L1 measurements for the candidate cell (block 920). For example, the network node (e.g., using communication manager 150 and/or reception component 1102, depicted in FIG. 11) may receive, from the UE, an L1 measurement report that indicates the one or more L1 measurements for the candidate cell, as described above.

Process 900 may include additional aspects, such as any single aspect or any combination of aspects described below and/or in connection with one or more other processes described elsewhere herein.

In a first aspect, the CSI measurement configuration is included in a serving cell configuration associated with an active serving cell.

In a second aspect, alone or in combination with the first aspect, the CSI measurement configuration configures one or more L1 measurements for the active serving cell.

In a third aspect, alone or in combination with one or more of the first and second aspects, the CSI measurement configuration is a first CSI measurement configuration that is independent from a second CSI measurement configuration configuring one or more L1 measurements for the active serving cell.

In a fourth aspect, alone or in combination with one or more of the first through third aspects, the CSI measurement configuration is included in a serving cell configuration associated with the candidate cell.

In a fifth aspect, alone or in combination with one or more of the first through fourth aspects, the CSI measurement configuration indicates a CMR for the candidate cell.

In a sixth aspect, alone or in combination with one or more of the first through fifth aspects, the CSI measurement configuration indicates an SMTC window for obtaining the one or more L1 measurements from one or more SSBs.

In a seventh aspect, alone or in combination with one or more of the first through sixth aspects, the L1 measurement report includes one or more SSB indexes and one or more PCIs associated with the one or more SSBs from which the one or more L1 measurements are obtained during the SMTC window.

In an eighth aspect, alone or in combination with one or more of the first through seventh aspects, the CSI measurement configuration indicates frequency information for obtaining the one or more L1 measurements from one or more inter-frequency SSBs.

In a ninth aspect, alone or in combination with one or more of the first through eighth aspects, process 900 includes transmitting, to the UE, a CSI report configuration for reporting the one or more L1 measurements for the candidate cell, wherein the L1 measurement report is associated with the CSI report configuration.

In a tenth aspect, alone or in combination with one or more of the first through ninth aspects, the CSI report configuration is included in a serving cell configuration associated with an active serving cell.

In an eleventh aspect, alone or in combination with one or more of the first through tenth aspects, the CSI report configuration configures a CSI report for the active serving cell.

In a twelfth aspect, alone or in combination with one or more of the first through eleventh aspects, the CSI report configuration is a first CSI report configuration that is independent from a second CSI report configuration for reporting one or more L1 measurements for the active serving cell.

In a thirteenth aspect, alone or in combination with one or more of the first through twelfth aspects, the CSI report configuration is included in a serving cell configuration associated with the candidate cell.

In a fourteenth aspect, alone or in combination with one or more of the first through thirteenth aspects, the L1 measurement report that indicates the one or more L1 measurements for the candidate cell is included in a MAC-CE.

In a fifteenth aspect, alone or in combination with one or more of the first through fourteenth aspects, the CSI measurement configuration indicates a CMR and an IMR for the candidate cell based at least in part on the one or more L1 measurements including an L1-SINR.

In a sixteenth aspect, alone or in combination with one or more of the first through fifteenth aspects, the CMR is a first NZP CSI-RS, and the IMR is the first NZP CSI-RS, a second NZP CSI-RS, or a ZP CSI-RS.

In a seventeenth aspect, alone or in combination with one or more of the first through sixteenth aspects, the CMR is a SSB, and the IMR is a ZP CSI-RS or an NZP CSI-RS.

In an eighteenth aspect, alone or in combination with one or more of the first through seventeenth aspects, process 900 includes receiving, from the UE, UE capability information related to a capability to obtain the one or more L1 measurements for the candidate cell, wherein the CSI measurement configuration is based at least in part on the UE capability information.

In a nineteenth aspect, alone or in combination with one or more of the first through eighteenth aspects, the UE capability information indicates a maximum number of candidate cells supported by the UE.

In a twentieth aspect, alone or in combination with one or more of the first through nineteenth aspects, the UE capability information indicates a maximum number of CMR reference signals supported by the UE per candidate cell.

In a twenty-first aspect, alone or in combination with one or more of the first through twentieth aspects, the UE capability information indicates a maximum number of IMR reference signals supported by the UE per candidate cell.

In a twenty-second aspect, alone or in combination with one or more of the first through twenty-first aspects, the UE capability information indicates whether the UE supports reporting an L1-SINR for the candidate cell.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include an L1 measurement component 1008, among other examples.

In some aspects, the apparatus 1000 may be configured to perform one or more operations described herein in connection with FIGS. 7A-7C. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive, from a network node, a CSI measurement configuration configuring one or more L1 measurements for a candidate cell. The L1 measurement component 1008 may obtain the one or more L1 measurements for the candidate cell based at least in part on the CSI measurement configuration. The transmission component 1004 may transmit, to the network node, an L1 measurement report that indicates the one or more L1 measurements for the candidate cell.

The reception component 1002 may receive, from the network node, a CSI report configuration for reporting the one or more L1 measurements for the candidate cell, wherein the L1 measurement report is associated with the CSI report configuration.

The transmission component 1004 may transmit, to the network node, UE capability information related to a capability to obtain the one or more L1 measurements for the candidate cell, wherein the CSI measurement configuration is based at least in part on the UE capability information.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150.

In some aspects, the apparatus 1100 may be configured to perform one or more operations described herein in connection with FIGS. 7A-7C. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The transmission component 1104 may transmit, to a UE, a CSI measurement configuration configuring one or more L1 measurements for a candidate cell. The reception component 1102 may receive, from the UE, an L1 measurement report that indicates the one or more L1 measurements for the candidate cell.

The transmission component 1104 may transmit, to the UE, a CSI report configuration for reporting the one or more L1 measurements for the candidate cell, wherein the L1 measurement report is associated with the CSI report configuration.

The reception component 1102 may receive, from the UE, UE capability information related to a capability to obtain the one or more L1 measurements for the candidate cell, wherein the CSI measurement configuration is based at least in part on the UE capability information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving, from a network node, a CSI measurement configuration configuring one or more L1 measurements for a candidate cell; obtaining the one or more L1 measurements for the candidate cell based at least in part on the CSI measurement configuration; and transmitting, to the network node, an L1 measurement report that indicates the one or more L1 measurements for the candidate cell.

Aspect 2: The method of Aspect 1, wherein the CSI measurement configuration is included in a serving cell configuration associated with an active serving cell.

Aspect 3: The method of Aspect 2, wherein the CSI measurement configuration configures one or more L1 measurements for the active serving cell.

Aspect 4: The method of Aspect 2, wherein the CSI measurement configuration is a first CSI measurement configuration that is independent from a second CSI measurement configuration configuring one or more L1 measurements for the active serving cell.

Aspect 5: The method of Aspect 1, wherein the CSI measurement configuration is included in a serving cell configuration associated with the candidate cell.

Aspect 6: The method of any of Aspects 1-5, wherein the CSI measurement configuration indicates a CMR for the candidate cell.

Aspect 7: The method of Aspect 1, wherein the CSI measurement configuration indicates an SMTC window for obtaining the one or more L1 measurements from one or more SSBs.

Aspect 8: The method of Aspect 7, wherein the L1 measurement report includes one or more SSB indexes and one or more PCIs associated with the one or more SSBs from which the one or more L1 measurements are obtained during the SMTC window.

Aspect 9: The method of any of Aspects 7-8, wherein the CSI measurement configuration indicates frequency information for obtaining the one or more L1 measurements from one or more inter-frequency SSBs.

Aspect 10: The method of any of Aspects 1-9, further comprising: receiving, from the network node, a CSI report configuration for reporting the one or more L1 measurements for the candidate cell, wherein the L1 measurement report is associated with the CSI report configuration.

Aspect 11: The method of Aspect 10, wherein the CSI report configuration is included in a serving cell configuration associated with an active serving cell.

Aspect 12: The method of Aspect 11, wherein the CSI report configuration configures a CSI report for the active serving cell.

Aspect 13: The method of Aspect 11, wherein the CSI report configuration is a first CSI report configuration that is independent from a second CSI report configuration for reporting one or more L1 measurements for the active serving cell.

Aspect 14: The method of Aspect 10, wherein the CSI report configuration is included in a serving cell configuration associated with the candidate cell.

Aspect 15: The method of any of Aspects 1-9, wherein the L1 measurement report that indicates the one or more L1 measurements for the candidate cell is included in a MAC-CE.

Aspect 16: The method of any of Aspects 1-15, wherein the CSI measurement configuration indicates a CMR and an IMR for the candidate cell based at least in part on the one or more L1 measurements including an L1-SINR.

Aspect 17: The method of Aspect 16, wherein the CMR is a first NZP CSI-RS, and wherein the IMR is the first NZP CSI-RS, a second NZP CSI-RS, or a ZP CSI-RS.

Aspect 18: The method of Aspect 16, wherein the CMR is a SSB, and wherein the IMR is a ZP CSI-RS or an NZP CSI-RS.

Aspect 19: The method of any of Aspects 1-18, further comprising: transmitting, to the network node, UE capability information related to a capability to obtain the one or more L1 measurements for the candidate cell, wherein the CSI measurement configuration is based at least in part on the UE capability information.

Aspect 20: The method of Aspect 19, wherein the UE capability information indicates a maximum number of candidate cells supported by the UE.

Aspect 21: The method of any of Aspects 19-20, wherein the UE capability information indicates a maximum number of CMR reference signals supported by the UE per candidate cell.

Aspect 22: The method of any of Aspects 19-21, wherein the UE capability information indicates a maximum number of IMR reference signals supported by the UE per candidate cell.

Aspect 23: The method of any of Aspects 19-22, wherein the UE capability information indicates whether the UE supports reporting an L1-SINR for the candidate cell.

Aspect 24: A method of wireless communication performed by a network node, comprising: transmitting, to a UE, a CSI measurement configuration configuring one or more L1 measurements for a candidate cell; and receiving, from the UE, an L1 measurement report that indicates the one or more L1 measurements for the candidate cell.

Aspect 25: The method of Aspect 24, wherein the CSI measurement configuration is included in a serving cell configuration associated with an active serving cell.

Aspect 26: The method of Aspect 25, wherein the CSI measurement configuration configures one or more L1 measurements for the active serving cell.

Aspect 27: The method of Aspect 25, wherein the CSI measurement configuration is a first CSI measurement configuration that is independent from a second CSI measurement configuration configuring one or more L1 measurements for the active serving cell.

Aspect 28: The method of Aspect 24, wherein the CSI measurement configuration is included in a serving cell configuration associated with the candidate cell.

Aspect 29: The method of any of Aspects 24-28, wherein the CSI measurement configuration indicates a CMR for the candidate cell.

Aspect 30: The method of Aspect 24, wherein the CSI measurement configuration indicates an SMTC window for obtaining the one or more L1 measurements from one or more SSBs.

Aspect 31: The method of Aspect 30, wherein the L1 measurement report includes one or more SSB indexes and one or more PCIs associated with the one or more SSBs from which the one or more L1 measurements are obtained during the SMTC window.

Aspect 32: The method of any of Aspects 30-31, wherein the CSI measurement configuration indicates frequency information for obtaining the one or more L1 measurements from one or more inter-frequency SSBs.

Aspect 33: The method of any of Aspects 24-32, further comprising: transmitting, to the UE, a CSI report configuration for reporting the one or more L1 measurements for the candidate cell, wherein the L1 measurement report is associated with the CSI report configuration.

Aspect 34: The method of Aspect 33, wherein the CSI report configuration is included in a serving cell configuration associated with an active serving cell.

Aspect 35: The method of Aspect 34, wherein the CSI report configuration configures a CSI report for the active serving cell.

Aspect 36: The method of Aspect 34, wherein the CSI report configuration is a first CSI report configuration that is independent from a second CSI report configuration for reporting one or more L1 measurements for the active serving cell.

Aspect 37: The method of Aspect 33, wherein the CSI report configuration is included in a serving cell configuration associated with the candidate cell.

Aspect 38: The method of any of Aspects 24-32, wherein the L1 measurement report that indicates the one or more L1 measurements for the candidate cell is included in a MAC-CE.

Aspect 39: The method of any of Aspects 24-38, wherein the CSI measurement configuration indicates a CMR and an IMR for the candidate cell based at least in part on the one or more L1 measurements including an L1-SINR.

Aspect 40: The method of Aspect 39, wherein the CMR is a first NZP CSI-RS, and wherein the IMR is the first NZP CSI-RS, a second NZP CSI-RS, or a ZP CSI-RS.

Aspect 41: The method of Aspect 39, wherein the CMR is a SSB, and wherein the IMR is a ZP CSI-RS or an NZP CSI-RS.

Aspect 42: The method of any of Aspects 24-41, further comprising: receiving, from the UE, UE capability information related to a capability to obtain the one or more L1 measurements for the candidate cell, wherein the CSI measurement configuration is based at least in part on the UE capability information.

Aspect 43: The method of Aspect 42, wherein the UE capability information indicates a maximum number of candidate cells supported by the UE.

Aspect 44: The method of any of Aspects 42-43, wherein the UE capability information indicates a maximum number of CMR reference signals supported by the UE per candidate cell.

Aspect 45: The method of any of Aspects 42-44, wherein the UE capability information indicates a maximum number of IMR reference signals supported by the UE per candidate cell.

Aspect 46: The method of any of Aspects 42-45, wherein the UE capability information indicates whether the UE supports reporting an L1-SINR for the candidate cell.

Aspect 47: An apparatus for wireless communication at a device, comprising a processor; memory coupled with the processor; and instructions stored in the memory and executable by the processor to cause the apparatus to perform the method of one or more of Aspects 1-46.

Aspect 48: A device for wireless communication, comprising a memory and one or more processors coupled to the memory, the one or more processors configured to perform the method of one or more of Aspects 1-46.

Aspect 49: An apparatus for wireless communication, comprising at least one means for performing the method of one or more of Aspects 1-46.

Aspect 50: A non-transitory computer-readable medium storing code for wireless communication, the code comprising instructions executable by a processor to perform the method of one or more of Aspects 1-46.

Aspect 51: A non-transitory computer-readable medium storing a set of instructions for wireless communication, the set of instructions comprising one or more instructions that, when executed by one or more processors of a device, cause the device to perform the method of one or more of Aspects 1-46.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving, from a network node, a channel state information (CSI) measurement configuration configuring one or more Layer 1 (L1) measurements for a candidate cell;
obtaining the one or more L1 measurements for the candidate cell based at least in part on the CSI measurement configuration; and
transmitting, to the network node, an L1 measurement report that indicates the one or more L1 measurements for the candidate cell.

2. The method of claim 1, wherein the CSI measurement configuration is included in a serving cell configuration associated with an active serving cell.

3. The method of claim 2, wherein the CSI measurement configuration configures one or more L1 measurements for the active serving cell.

4. The method of claim 2, wherein the CSI measurement configuration is a first CSI measurement configuration that is independent from a second CSI measurement configuration configuring one or more L1 measurements for the active serving cell.

5. The method of claim 1, wherein the CSI measurement configuration is included in a serving cell configuration associated with the candidate cell.

6. The method of claim 1, wherein the CSI measurement configuration indicates a channel measurement resource (CMR) for the candidate cell.

7. The method of claim 1, wherein the CSI measurement configuration indicates a synchronization signal block (SSB) measurement timing configuration (SMTC) window for obtaining the one or more L1 measurements from one or more SSBs.

8. The method of claim 7, wherein the L1 measurement report includes one or more SSB indexes and one or more physical cell identities (PCIs) associated with the one or more SSBs from which the one or more L1 measurements are obtained during the SMTC window.

9. The method of claim 7, wherein the CSI measurement configuration indicates frequency information for obtaining the one or more L1 measurements from one or more inter-frequency SSBs.

10. The method of claim 1, further comprising:
receiving, from the network node, a CSI report configuration for reporting the one or more L1 measurements for the candidate cell, wherein the L1 measurement report is associated with the CSI report configuration.

11. The method of claim 10, wherein the CSI report configuration is included in a serving cell configuration associated with an active serving cell.

12. The method of claim 11, wherein the CSI report configuration configures a CSI report for the active serving cell.

13. The method of claim 11, wherein the CSI report configuration is a first CSI report configuration that is independent from a second CSI report configuration for reporting one or more L1 measurements for the active serving cell.

14. The method of claim 10, wherein the CSI report configuration is included in a serving cell configuration associated with the candidate cell.

15. The method of claim 1, wherein the L1 measurement report that indicates the one or more L1 measurements for the candidate cell is included in a medium access control (MAC) control element (MAC-CE).

16. The method of claim 1, wherein the CSI measurement configuration indicates a channel measurement resource (CMR) and an interference measurement resource (IMR) for the candidate cell based at least in part on the one or more L1 measurements including an L1 signal-to-interference-plus-noise ratio (L1-SINR).

17. The method of claim 16, wherein the CMR is a first non-zero power (NZP) CSI reference signal (CSI-RS) (NZP-CSI-RS), and wherein the IMR is the first NZP CSI-RS, a second NZP CSI-RS, or a zero power (ZP) CSI-RS.

18. The method of claim 16, wherein the CMR is a synchronization signal block (SSB), and wherein the IMR is a zero power (ZP) CSI reference signal (CSI-RS) (ZP CSI-RS) or a non-zero power (NZP) CSI-RS (NZP CSI-RS).

19. The method of claim 1, further comprising:
transmitting, to the network node, UE capability information related to a capability to obtain the one or more L1 measurements for the candidate cell, wherein the CSI measurement configuration is based at least in part on the UE capability information.

20. The method of claim 19, wherein the UE capability information indicates a maximum number of candidate cells supported by the UE.

21. The method of claim 19, wherein the UE capability information indicates a maximum number of channel measurement resource (CMR) reference signals supported by the UE per candidate cell.

22. The method of claim 19, wherein the UE capability information indicates a maximum number of interference measurement resource (IMR) reference signals supported by the UE per candidate cell.

23. The method of claim 19, wherein the UE capability information indicates whether the UE supports reporting an L1 signal-to-interference-plus-noise ratio (L1-SINR) for the candidate cell.

24. A method of wireless communication performed by a network node, comprising:
transmitting, to a user equipment (UE), a channel state information (CSI) measurement configuration configuring one or more Layer 1 (L1) measurements for a candidate cell; and
receiving, from the UE, an L1 measurement report that indicates the one or more L1 measurements for the candidate cell.

25. The method of claim 24, wherein the CSI measurement configuration is included in a serving cell configuration associated with an active serving cell.

26. The method of claim 25, wherein the CSI measurement configuration configures one or more L1 measurements for the active serving cell.

27. The method of claim 25, wherein the CSI measurement configuration is a first CSI measurement configuration that is independent from a second CSI measurement configuration configuring one or more L1 measurements for the active serving cell.

28. The method of claim 24, wherein the CSI measurement configuration is included in a serving cell configuration associated with the candidate cell.

29. The method of claim 24, wherein the CSI measurement configuration indicates a channel measurement resource (CMR) for the candidate cell.

30. The method of claim 24, wherein the CSI measurement configuration indicates a synchronization signal block (SSB) measurement timing configuration (SMTC) window for obtaining the one or more L1 measurements from one or more SSBs.

31. The method of claim 30, wherein the L1 measurement report includes one or more SSB indexes and one or more physical cell identities (PCIs) associated with the one or more SSBs from which the one or more L1 measurements are obtained during the SMTC window.

32. The method of claim 30, wherein the CSI measurement configuration indicates frequency information for obtaining the one or more L1 measurements from one or more inter-frequency SSBs.

33. The method of claim 24, further comprising:
transmitting, to the UE, a CSI report configuration for reporting the one or more L1 measurements for the candidate cell, wherein the L1 measurement report is associated with the CSI report configuration.

34. The method of claim 33, wherein the CSI report configuration is included in a serving cell configuration associated with an active serving cell.

35. The method of claim 34, wherein the CSI report configuration configures a CSI report for the active serving cell.

36. The method of claim 34, wherein the CSI report configuration is a first CSI report configuration that is independent from a second CSI report configuration for reporting one or more L1 measurements for the active serving cell.

37. The method of claim 33, wherein the CSI report configuration is included in a serving cell configuration associated with the candidate cell.

38. The method of claim 24, wherein the L1 measurement report that indicates the one or more L1 measurements for the candidate cell is included in a medium access control (MAC) control element (MAC-CE).

39. The method of claim 24, wherein the CSI measurement configuration indicates a channel measurement resource (CMR) and an interference measurement resource (IMR) for the candidate cell based at least in part on the one or more L1 measurements including an L1 signal-to-interference-plus-noise ratio (L1-SINR).

40. The method of claim 39, wherein the CMR is a first non-zero power (NZP) CSI reference signal (CSI-RS) (NZP-CSI-RS), and wherein the IMR is the first NZP CSI-RS, a second NZP CSI-RS, or a zero power (ZP) CSI-RS.

41. The method of claim 39, wherein the CMR is a synchronization signal block (SSB), and wherein the IMR is a zero power (ZP) CSI reference signal (CSI-RS) (ZP CSI-RS) or a non-zero power (NZP) CSI-RS (NZP CSI-RS).

42. The method of claim 24, further comprising:
receiving, from the UE, UE capability information related to a capability to obtain the one or more L1 measurements for the candidate cell, wherein the CSI measurement configuration is based at least in part on the UE capability information.

43. The method of claim 42, wherein the UE capability information indicates a maximum number of candidate cells supported by the UE.

44. The method of claim 42, wherein the UE capability information indicates a maximum number of channel measurement resource (CMR) reference signals supported by the UE per candidate cell.

45. The method of claim 42, wherein the UE capability information indicates a maximum number of interference measurement resource (IMR) reference signals supported by the UE per candidate cell.

46. The method of claim 42, wherein the UE capability information indicates whether the UE supports reporting an L1 signal-to-interference-plus-noise ratio (L1-SINR) for the candidate cell.

47. A user equipment (UE) for wireless communication, comprising:
a memory; and
one or more processors, coupled to the memory, configured to:
receive, from a network node, a channel state information (CSI) measurement configuration configuring one or more Layer 1 (L1) measurements for a candidate cell;
obtain the one or more L1 measurements for the candidate cell based at least in part on the CSI measurement configuration; and
transmit, to the network node, an L1 measurement report that indicates the one or more L1 measurements for the candidate cell.

48. The UE of claim 47, wherein the CSI measurement configuration is included in a serving cell configuration associated with an active serving cell.

49. The UE of claim 48, wherein the CSI measurement configuration configures one or more L1 measurements for the active serving cell.

50. The UE of claim 48, wherein the CSI measurement configuration is a first CSI measurement configuration that is independent from a second CSI measurement configuration configuring one or more L1 measurements for the active serving cell.

51. The UE of claim 47, wherein the CSI measurement configuration is included in a serving cell configuration associated with the candidate cell.

52. The UE of claim 47, wherein the CSI measurement configuration indicates a channel measurement resource (CMR) for the candidate cell.

53. The UE of claim 47, wherein the CSI measurement configuration indicates a synchronization signal block (SSB) measurement timing configuration (SMTC) window for obtaining the one or more L1 measurements from one or more SSBs.

54. The UE of claim 53, wherein the L1 measurement report includes one or more SSB indexes and one or more physical cell identities (PCIs) associated with the one or more SSBs from which the one or more L1 measurements are obtained during the SMTC window.

55. The UE of claim 53, wherein the CSI measurement configuration indicates frequency information for obtaining the one or more L1 measurements from one or more inter-frequency SSBs.

56. The UE of claim 47, wherein the one or more processors are further configured to:
receive, from the network node, a CSI report configuration for reporting the one or more L1 measurements for the candidate cell, wherein the L1 measurement report is associated with the CSI report configuration.

57. The UE of claim 56, wherein the CSI report configuration is included in a serving cell configuration associated with an active serving cell.

58. The UE of claim 57, wherein the CSI report configuration configures a CSI report for the active serving cell.

59. The UE of claim 57, wherein the CSI report configuration is a first CSI report configuration that is independent from a second CSI report configuration for reporting one or more L1 measurements for the active serving cell.

60. The UE of claim 56, wherein the CSI report configuration is included in a serving cell configuration associated with the candidate cell.

61. The UE of claim 47, wherein the L1 measurement report that indicates the one or more L1 measurements for the candidate cell is included in a medium access control (MAC) control element (MAC-CE).

62. The UE of claim 47, wherein the CSI measurement configuration indicates a channel measurement resource (CMR) and an interference measurement resource (IMR) for the candidate cell based at least in part on the one or more L1 measurements including an L1 signal-to-interference-plus-noise ratio (L1-SINR).

63. The UE of claim 62, wherein the CMR is a first non-zero power (NZP) CSI reference signal (CSI-RS) (NZP-CSI-RS), and wherein the IMR is the first NZP CSI-RS, a second NZP CSI-RS, or a zero power (ZP) CSI-RS.

64. The UE of claim 62, wherein the CMR is a synchronization signal block (SSB), and wherein the IMR is a zero power (ZP) CSI reference signal (CSI-RS) (ZP CSI-RS) or a non-zero power (NZP) CSI-RS (NZP CSI-RS).

65. The UE of claim 47, wherein the one or more processors are further configured to:
transmit, to the network node, UE capability information related to a capability to obtain the one or more L1 measurements for the candidate cell, wherein the CSI measurement configuration is based at least in part on the UE capability information.

66. The UE of claim 65, wherein the UE capability information indicates a maximum number of candidate cells supported by the UE.

67. The UE of claim 65, wherein the UE capability information indicates a maximum number of channel measurement resource (CMR) reference signals supported by the UE per candidate cell.

68. The UE of claim 65, wherein the UE capability information indicates a maximum number of interference measurement resource (IMR) reference signals supported by the UE per candidate cell.

69. The UE of claim 65, wherein the UE capability information indicates whether the UE supports reporting an L1 signal-to-interference-plus-noise ratio (L1-SINR) for the candidate cell.

70. A network node for wireless communication, comprising:
a memory; and
one or more processors, coupled to the memory, configured to:
transmit, to a user equipment (UE), a channel state information (CSI) measurement configuration configuring one or more Layer 1 (L1) measurements for a candidate cell; and
receive, from the UE, an L1 measurement report that indicates the one or more L1 measurements for the candidate cell.

71. The network node of claim 70, wherein the CSI measurement configuration is included in a serving cell configuration associated with an active serving cell.

72. The network node of claim 71, wherein the CSI measurement configuration configures one or more L1 measurements for the active serving cell.

73. The network node of claim 71, wherein the CSI measurement configuration is a first CSI measurement configuration that is independent from a second CSI measurement configuration configuring one or more L1 measurements for the active serving cell.

74. The network node of claim 70, wherein the CSI measurement configuration is included in a serving cell configuration associated with the candidate cell.

75. The network node of claim 70, wherein the CSI measurement configuration indicates a channel measurement resource (CMR) for the candidate cell.

76. The network node of claim 70, wherein the CSI measurement configuration indicates a synchronization signal block (SSB) measurement timing configuration (SMTC) window for obtaining the one or more L1 measurements from one or more SSBs.

77. The network node of claim 76, wherein the L1 measurement report includes one or more SSB indexes and one or more physical cell identities (PCIs) associated with the one or more SSBs from which the one or more L1 measurements are obtained during the SMTC window.

78. The network node of claim 76, wherein the CSI measurement configuration indicates frequency information for obtaining the one or more L1 measurements from one or more inter-frequency SSBs.

79. The network node of claim 70, wherein the one or more processors are further configured to:
transmit, to the UE, a CSI report configuration for reporting the one or more L1 measurements for the candidate cell, wherein the L1 measurement report is associated with the CSI report configuration.

80. The network node of claim 79, wherein the CSI report configuration is included in a serving cell configuration associated with an active serving cell.

81. The network node of claim 80, wherein the CSI report configuration configures a CSI report for the active serving cell.

82. The network node of claim 80, wherein the CSI report configuration is a first CSI report configuration that is independent from a second CSI report configuration for reporting one or more L1 measurements for the active serving cell.

83. The network node of claim 79, wherein the CSI report configuration is included in a serving cell configuration associated with the candidate cell.

84. The network node of claim 70, wherein the L1 measurement report that indicates the one or more L1 measurements for the candidate cell is included in a medium access control (MAC) control element (MAC-CE).

85. The network node of claim 70, wherein the CSI measurement configuration indicates a channel measurement resource (CMR) and an interference measurement resource (IMR) for the candidate cell based at least in part on the one or more L1 measurements including an L1 signal-to-interference-plus-noise ratio (L1-SINR).

86. The network node of claim 85, wherein the CMR is a first non-zero power (NZP) CSI reference signal (CSI-RS) (NZP-CSI-RS), and wherein the IMR is the first NZP CSI-RS, a second NZP CSI-RS, or a zero power (ZP) CSI-RS.

87. The network node of claim 85, wherein the CMR is a synchronization signal block (SSB), and wherein the IMR is a zero power (ZP) CSI reference signal (CSI-RS) (ZP CSI-RS) or a non-zero power (NZP) CSI-RS (NZP CSI-RS).

88. The network node of claim 70, wherein the one or more processors are further configured to:
receive, from the UE, UE capability information related to a capability to obtain the one or more L1 measurements for the candidate cell, wherein the CSI measurement configuration is based at least in part on the UE capability information.

89. The network node of claim 88, wherein the UE capability information indicates a maximum number of candidate cells supported by the UE.

90. The network node of claim 88, wherein the UE capability information indicates a maximum number of channel measurement resource (CMR) reference signals supported by the UE per candidate cell.

91. The network node of claim 88, wherein the UE capability information indicates a maximum number of interference measurement resource (IMR) reference signals supported by the UE per candidate cell.

92. The network node of claim 88, wherein the UE capability information indicates whether the UE supports reporting an L1 signal-to-interference-plus-noise ratio (L1-SINR) for the candidate cell.

93. A non-transitory computer-readable medium storing a set of instructions for wireless communication, the set of instructions comprising:
one or more instructions that, when executed by one or more processors of a user equipment (UE), cause the UE to:
receive, from a network node, a channel state information (CSI) measurement configuration configuring one or more Layer 1 (L1) measurements for a candidate cell;
obtain the one or more L1 measurements for the candidate cell based at least in part on the CSI measurement configuration; and
transmit, to the network node, an L1 measurement report that indicates the one or more L1 measurements for the candidate cell.

94. A non-transitory computer-readable medium storing a set of instructions for wireless communication, the set of instructions comprising:
one or more instructions that, when executed by one or more processors of a network node, cause the network node to:
transmit, to a user equipment (UE), a channel state information (CSI) measurement configuration configuring one or more Layer 1 (L1) measurements for a candidate cell; and
receive, from the UE, an L1 measurement report that indicates the one or more L1 measurements for the candidate cell.

95. An apparatus for wireless communication, comprising:
means for receiving, from a network node, a channel state information (CSI) measurement configuration configuring one or more Layer 1 (L1) measurements for a candidate cell;
means for obtaining the one or more L1 measurements for the candidate cell based at least in part on the CSI measurement configuration; and
means for transmitting, to the network node, an L1 measurement report that indicates the one or more L1 measurements for the candidate cell.

96. An apparatus for wireless communication, comprising:
means for transmitting, to a user equipment (UE), a channel state information (CSI) measurement configuration configuring one or more Layer 1 (L1) measurements for a candidate cell; and
means for receiving, from the UE, an L1 measurement report that indicates the one or more L1 measurements for the candidate cell.
